(19) United States
(12) Patent Application Publication
(10) Pub. No.: US 2008/0106632 A1
(43) Pub. Date: May 8, 2008

(54) CAMERA DEVICE AND METHOD FOR MAKING SAME

(75) Inventor: KUN-I YUAN, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/671,582

(22) Filed: Feb. 6, 2007

(30) Foreign Application Priority Data
Nov. 2, 2006 (CN) 200610201059.2

(51) Int. Cl. H04N 5/225

(52) U.S. Cl. 348/340; 348/E05.024

(57) ABSTRACT

An exemplary camera device includes a holder, an image sensor, at least one optical element, and a barrel unit. The barrel unit includes a barrel and at least one lens received therein, and the barrel is threadedly coupled to the holder. The image sensor and the at least one optical element are received in the holder, and the at least one optical element is positioned between the image sensor and the barrel unit.

### BACKGROUND

1. Technical Field

The present invention relates generally to optical imaging and, more particularly, to a camera device and a method for making the camera device.

2. Description of Related Art

With the development of the optical imaging technology, camera devices are widely used in electronic devices, such as digital camera, and mobile phones.

Generally, a camera device includes a barrel and a plurality of optical elements (e.g., lenses, and infrared-cut filters) received in the barrel. In assembly, the optical elements are assembled into the barrel. When imaging quality of the camera device after assembly fails to reach a set standard, some optical elements, especially some expensive ones, are removed so as to be recycled. Typical methods for removing the optical elements include: pushing a to-be-recycled optical element out of the barrel; or cutting the barrel and obtaining the to-be-recycled optical element.

However, the to-be-recycled optical element may be easily damaged and the other optical elements may also be damaged as when using the above two methods. Furthermore, it is troublesome to recycle the optical element, thus increasing cost of reassembling camera device.

It is therefore desirable to find a new camera device and a new method capable of overcoming the above mentioned problems.

### SUMMARY

In a preferred embodiment, a camera device includes a holder, an image sensor, at least one optical element, and a barrel unit. The barrel unit includes a barrel and at least one lens received therein, and the barrel is threadedly coupled to the holder. The image sensor and the at least one optical element are received in the holder, and the at least one optical element is positioned between the image sensor and the barrel unit.

A method for assembling a camera device includes the steps of: placing an image sensor, and at least one optical element filter in a holder in this order from an imaging side to an object side; placing at least one lens into a barrel, thus forming a barrel unit; and threadedly coupling the barrel unit to the holder in such a manner that the at least one lens faces the at least one optical element.

### BRIEF DESCRIPTION OF THE DRAWING

Many aspects of embodiments can be better understood with reference to the following drawing. The components in the drawing are not necessarily drawn to scale, the emphasis instead being placed upon clearly illustrating the principles of the present embodiment. Moreover, in the drawing, like reference numerals designate corresponding parts throughout the several views.

FIG. 1 is a schematic, cross-sectional view of a camera device according to a preferred embodiment.

### DETAILED DESCRIPTION OF THE EMBODIMENTS

Embodiments will now be described in detail below with reference to the drawing.

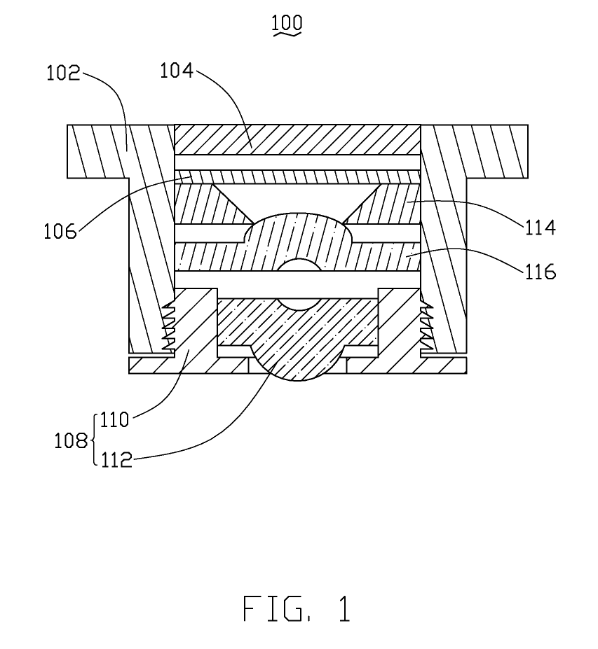

Referring to FIG. 1, a camera device 100 according to a preferred embodiment is shown. The camera device 100 includes a holder 102, an image sensor 104, a filter 106, a spacer 114, a first lens 116, and a barrel unit 108. The image sensor 104, the filter 106, the spacer 114, and the first lens 116 are received in the holder 102 in this order from an imaging side to an object side. The barrel unit 108 is threadedly coupled to the holder 102 in such a manner that the filter 106, the spacer 114, and the first lens 116 are positioned between the image sensor 104 and the barrel unit 108. The barrel unit 108 includes a barrel 110 and at least one lens (e.g., a second lens 112) received therein.

The image sensor 104 can be a charge-coupled device (CCD) or a complementary metal oxide semiconductor device (CMOS). The filter 106 can be an infrared-cut filter. The lens 112 can be an expensive lens, for example, a glass lens, or a diffraction optical lens. The holder 102 and the barrel 110 can be made of a material selected from the group consisting of plastic and metal. The image sensor 104, the filter 106, the spacer 114, and the first lens 116 can be fixed in the holder 102 using glue, and the second lens 112 can be secured in the barrel 110 using glue as well.

A method for assembling the camera device 100 is also provided. Referring to FIG. 1 again, the method includes the steps of: placing the image sensor 104, the filter 106, the spacer 114, and the first lens 116 in the holder 102 in this order from an imaging side to an object side; placing the second lens 112 into the barrel 110, thus forming the barrel unit 108; and coupling the barrel unit 108 to the holder 102 in such a manner that the second lens 112 faces the first lens 116.

If the second lens 112 fails to work well together with the other optical elements, imaging quality of the camera device 100 fails to reach a set standard. In this case, reassembly of the camera device 100 is needed. The barrel unit 108 can be replaced with another one easily without damaging the other optical elements because the barrel unit 108 is threadedly coupled to the holder 102. The barrel unit 108 including the expensive lens 112 can be used in the assembly of other camera devices. Therefore, efficiency of reassembling camera device is enhanced and cost of reassembly is reduced. The camera device 100 assembled using the present method has identical advantages.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A camera device comprising:
a holder;
an image sensor;
at least one optical element; and
a barrel unit comprising a barrel and at least one lens received therein, the barrel being threadedly coupled to the holder;
wherein the image sensor and the at least one optical element are received in the holder, and the at least one optical element is positioned between the image sensor and the barrel unit.

2. The camera device as claimed in claim 1, wherein the at least one optical element is an infrared-cut filter.

3. The camera device as claimed in claim 1, wherein the at least one lens is a diffraction optical lens.

4. A method for making a camera device, comprising the steps of:
placing an image sensor, and at least one optical element into a holder;
placing at least one lens into a barrel, thus forming a barrel unit; and
threadedly coupling the barrel unit to the holder in such a manner that the at least one lens faces the at least one optical element.

5. The method as claimed in claim 4, wherein the at least one optical element is an infrared-cut filter.

6. The method as claimed in claim 4, wherein the at least one lens is a diffraction optical lens.
